(19) United States
(12) Patent Application Publication
(10) Pub. No.: US 2006/0223635 A1
(43) Pub. Date: Oct. 5, 2006

(54) METHOD AND APPARATUS FOR AN ON-SCREEN/OFF-SCREEN FIRST PERSON GAMING EXPERIENCE

(75) Inventor: Louis B. Rosenberg, Pismo Beach, CA (US)

Correspondence Address: SINSHEIMER JUHNKE LEBENS & MCIVOR, LLP, 1010 PEACH STREET, P.O. BOX 31, SAN LUIS OBISPO, CA, 93406, US

(73) Assignee: Outland Research, Pismo Beach, CA (US)

(21) Appl. No.: 11/278,531

(22) Filed: Apr. 3, 2006

Related U.S. Application Data
(60) Provisional application No. 60/668,299, filed on Apr. 4, 2005.

(51) Int. Cl. A63F 13/00

(52) U.S. Cl. 463/37

(57) ABSTRACT

An interactive apparatus is described comprising a multiple portable gaming systems interconnected with a wireless communications link. Each gaming system comprises a visual display, a user interface, a communications link, a computer system and gaming software. The gaming system can display the real-time real-world images captured by a video camera mounted on the gaming system overlaid with simulated gaming objects and events. In this way a combined on-screen off-screen gaming experience is provided for the user that merges real-world events with simulated gaming actions.

This application claims benefit under 35 U.S.C. § 119(e) to U.S. Provisional Application No. 60/668,299 filed Apr. 4, 2005, which United States provisional patent application is hereby fully incorporated herein by reference.

### BACKGROUND OF THE INVENTION

1. Field of the Invention

The invention relates to gaming networks in general and interactive person to person gaming systems using portable computing systems in particular.

2. Discussion of the Related Art

Whether implemented on a personal computer, television-based gaming console, or handheld gaming system, traditional video games allow players to manipulate on-screen characters and thereby engage in on-screen challenges or competitions. While such on-screen challenges or competitions are fun and engaging for players, they often pull players away from the real physical world and cause them to sit mesmerized in a single location for hours at a time, fixated upon a glowing screen. This is true even for games played upon Portable Gaming Systems. Such devices are small and handheld and can allow players to walk around, but the gaming action is still restricted entirely to the screen. As a result players using Portable Gaming Systems just sit in one spot (or stand in one spot) and passively stare down at their screen.

What is therefore needed is a novel means of combining the benefits of computer generated displayed content upon a portable gaming system with real-world off-screen activities such that a player who is playing a game is actively moving about a real physical space as part of the gaming experience. To achieve this a novel method of on-screen/off-screen first-person gaming is disclosed herein. By “first-person” it is meant that the player plays the game from his or her real-world vantage point as he or she moved about within his or her real physical space, not from the outside perspective of looking in upon some other world that is displayed upon their screen. By “on-screen/off-screen” it is meant that the gaming action is a merger of simulated gaming action generated by the gaming software running upon the portable gaming system and a real-world experience that occurs as the player moves about the real physical space. A key feature of this invention is the ability of the player to move about a real physical space while carrying a portable gaming system, as the player changes his or her location and/or orientation within said real physical space, his or her first person perspective within the simulated gaming action is updated and displayed upon said portable gaming system. This feature, combined with other methods and features disclosed herein, creates a on-screen/off-screen first person gaming experience for players that turns their room, their house, their yard, a playground, or any other real physical space into a merged real/simulated playing field for engaging computer generated content as moderated by software running upon said portable gaming system in response to said players changing physical location within a real physical space.

### BRIEF DESCRIPTION OF THE DRAWINGS

Preferred embodiments of the invention will be described in conjunction with the following drawings, in which:

FIG. 1 is a system block diagram of the gaming system including the various subsystems incorporated into the portable gaming system; and

FIG. 1B is a front view of the portable gaming system showing the display, the player input controls, and the video camera as pointed away from the video camera; and

FIG. 1C is a side view of the portable gaming system as held at angle to the floor; and

FIG. 2 is a system block diagram of multiple portable gaming systems intercommunicating with each other; and

FIG. 3 is a system block diagram of multiple portable gaming systems communicating with a central hub; and

FIG. 4 is a flowchart of the image acquisition and display process in the portable gaming system; and

FIG. 5 is a flowchart of the polling of multiple portable gaming systems; and

FIG. 6A is a view of the portable gaming system with the image captured by the video camera; and

FIG. 6B is a view of the portable gaming system with the same image darkened to simulate nighttime conditions; and

FIG. 6C is a flow diagram showing the process of darkening the video image to simulate various conditions; and

FIG. 7 is a picture of a gaming system showing computer generated cracks; and

FIG. 8 is the screen display of the gaming system where the aiming system consisting of crosshairs is shown; and

FIG. 8A is a flow diagram showing the process of selecting and firing a weapon targeted by crosshairs; and

FIG. 9 is the screen display of the gaming system where a simulated laser weapon has been fired at a bean bag chair in the real world; and

FIG. 10 is the screen display of the gaming system showing the virtual effects on the bean bag chair in the real world of the simulated laser beam; and

FIG. 10A is a flowchart of the interaction of the weapons cache and the ammunition; and

FIG. 11 is the screen display of the gaming system showing the placement of simulated images, in this instance a pyramid; and

FIG. 12 is the screen display of the gaming system showing the placement of simulated images, in this instance a barrier; and

FIG. 13 is the screen display of the gaming system showing a fuel meter and ammunition meter for the mobile toy vehicle being operated; and

FIG. 14 is a wristwatch implementation of the portable gaming system.

### SUMMARY

The preferred embodiment of an apparatus for user entertainment, said apparatus comprising: a plurality of portable gaming systems and a plurality of communication links between the gaming systems.

The portable gaming system further comprises: a virtual weapons system; a video camera; a communications link interface; a gaming software; wherein said gaming software controls a camera, a location system, a ranging system, an audio input device, and audio output device, player input, and a light emitting/light detecting pair.

Also provided is a method for controlling an apparatus that entertains, said method comprising: obtaining an image from the portable gaming system; transferring the image to a user game console; overlaying the image with a virtual object; displaying the overlaid image with the virtual object on the screen.

### DETAILED DESCRIPTION

The apparatus of the preferred embodiment includes a portable gaming system, the portable gaming system being a handheld gaming machine that includes one or more computer processors running gaming software, a visual display, and manual player-interface controls.

The portable gaming system can be a commercially available device such as a PlayStation Portable by Sony, Gameboy Advance from Nintendo, a Nintendo DS portable gaming system from Nintendo, or an N-Gage portable gaming system from Nokia.

In many embodiments disclosed herein the portable gaming system equipped with a video camera that is aimed away from the player into the real physical space the player is traversing with an orientation such that the camera image provides a first person view of that physical space that reasonably approximates the first person view that the player has when standing within that space and looking forward. The camera is generally affixed to the portable gaming system and aimed backward away from the player. This provides an approximate first person view, for the height of the camera and orientation does not exactly match the height and orientation of the player's actual eyes as they look upon the real physical space, and yet the first person illusion is still effective. In fact it is substantially more effective than affixing the camera to glasses upon the players face (as might be done in Augmented Reality research system) for although this would achieve a very accurate first person perspective, the camera view would change as the player moves his or her head position and orientation relative to his or her body, something that becomes very confusing, especially as the player tries to also look down at the screen of the portable gaming system to play the game. For this reason the preferred embodiment is a camera that is affixed to the portable gaming system and thereby changes its position and orientation as the portable gaming system is carried by the player about the real physical space, the camera pointed away from the player such that it gives an approximate first person view for the player.

In many embodiments of this invention a GPS sensor and a magnetometer is also included, affixed to the portable gaming system such that it tracks the changing position and orientation of the portable gaming system as it is carried about the real physical space by the player during the gaming action. Data from the GPS sensor and a magnetometer is used by software running upon the portable gaming system to update gaming action, including displayed gaming action drawn graphically upon the screen of the portable gaming system.

In some embodiments other sensors are connected to the portable gaming system for enabling the shared real/simulated gaming experience. For example accelerometers can be affixed to the portable gaming system to detected changing position and/or orientation of the portable gaming system with respect to the real physical space. Also ultrasound sensors can be affixed to the portable gaming system to detect the distance of real physical objects (such as walls and furniture) from the portable gaming system within the real physical space. Also a microphone can be connected to the portable gaming system to capturing sounds as the player carries the portable gaming system about the real physical space.

In many embodiments a plurality of portable gaming systems are used, each portable gaming system being carried about the physical space by a different player. In this way a plurality of players can play a combined game within the same real physical space, the first person perspective of the gaming action provided to each of the players being different based upon each of their different positions and orientations within the real physical space (depending upon where and how they are standing within the real physical space). In some such embodiments a bi-directional communication link is included in the portable gaming systems used by each of the players, the bi-directional communication link allowing each of the portable gaming systems to exchange game related data with other of the portable gaming systems. In some embodiments the game related data that is exchanged between portable gaming systems includes GPS data and/or magnetometer data such that each players portable gaming system receives data about the position and/or orientation of the other portable gaming systems within the playing space. In some embodiments the game related data that is exchanged between portable gaming systems includes image data from cameras such that a player using one portable gaming system can display image data upon his or her screen that shows the approximate first person perspective of another of the players as captured by the camera affixed to the portable gaming system of that other of the players. In some embodiments the game related data that is exchanged includes data used to determine if one player successfully targets and/or fires upon another of the players during simulated weapon's fire gaming action. In some embodiments the game related data that is exchanged includes the spatial location of simulated objects that one of the players places (or moves) within the real/simulated playing field for other of the players to seek and find. In some embodiments the game related data that is exchanged includes the spatial location of a simulated note as well as the textual content of the note, the note being a simulated object that a first player places at a particular spatial location within the real/simulated playing field for other players to find and read.

The methods and apparatus described above are made even more compelling when used by multiple players. For example two players, each controlling their own portable gaming system can be present in the same real physical space and can play games that are responsive to each other's location and actions within the real physical space. In some embodiments the portable gaming systems of two players are coordinated through a bi-directional communication link between them (such as Bluetooth). In this way the gaming action upon both gaming systems can be coordinated. The two players of the two gaming systems can thereby engage in a shared gaming experience, the shared gaming experience dependent not just upon the simulation software running upon each of their portable gaming systems but also dependent upon how the players carry the portable gaming systems about the real physical space. This becomes particularly interesting in embodiments wherein a first player can see the second player upon the first player's display as captured by the camera mounted upon the first player's portable gaming system. Similarly the second player can see the first player as captured by the camera mounted upon the second player portable gaming system. In this way the two players can selectively see each other on their displays and thereby, follow, compete, fight, or otherwise interact as moderated by the displayed gaming action upon their portable gaming systems.

In some embodiments each player can “fire upon” the other using simulated weapons, the targeting of the weapons dependent upon the position and orientation of the portable gaming system that fired the weapon as carried by the player about the real physical space. Whether or not the simulated weapon hits the other of the two players is dependent upon the position and optionally the orientation of the portable gaming system that was fired upon. If a hit was determined, gaming action is updated. The updating of gaming action can include, for example, the portable gaming system of one or both players displaying a simulated explosion image overlaid upon the camera image that is being displayed upon the screen of the portable gaming system (or systems). The updating of gaming action can also include, for example, the portable gaming system of one or both players displaying a simulated explosion sound upon the portable gaming system (or systems) through speakers and/or headphones. The updating of gaming action can also include, for example, player scores being updated upon the portable gaming system (or systems). The updating of gaming action can also include the computation of and/or display of simulated damage upon the portable gaming system, the simulated gaming affecting the functionality of the player. For example, if a player has suffered simulated damage (as determined by the software running upon one or more portable gaming systems) that player can be imposed with hampered functionality. The hampered functionality could limit the player's ability to fire weapons, use shields, and or perform other simulated functions. The simulated damage could even obscure the camera feedback displayed upon the portable gaming system of that player, turning the screen black or reducing the displayed fidelity of the camera feedback. In this way the simulated gaming action merges the on-screen and off-screen play action. The system can be designed to support a larger number of players, each with their own portable gaming system.

In some embodiments of the present invention a light emitter and light detector is included, also affixed to the portable gaming system, the light emitter aimed away from the portable gaming system in the same approximate direction as the camera (mentioned previously) is aimed. The light detector can be aimed in the same direction as the emitter (away from the portable gaming system) or can be omni-directional such that it detects light signals from multiple directions. In some embodiments a light detector is not included and replaced by the camera itself (which can function to detect light sources using image processing techniques). The purpose of the light emitter and light detector is to aid in the determination of whether a simulated weapon fired by one player causes a hit upon another player. This is achieved through a method such that when a player of a first portable gaming system fires a simulated weapon at a player of a second portable gaming system, a light emitter controlled by the software running upon the first portable gaming system outputs a pulse of light from the first portable gaming system in a direction determined by the position and orientation that the first portable gaming system as held by the first player. At the same time the software running upon a second portable gaming system is monitoring a light detector connected to the second portable gaming system. If a pulse of light is detected by the software running upon the second portable gaming system it may be determined that the first player scored a weapon hit upon the second player. Other information may be used by the software to determine if a hit was caused by the first player, such as data transmitted between the first and second portable gaming systems over the communication link, the data indicating that the first portable gaming system fired a weapon. Other information may also be used by the software to determine if a hit was caused by the first player, such as whether or not a simulated shield was engaged by the second player within the simulated gaming action. The light emitters and light detectors described herein can be visible light emitters and detectors, ultra violate light emitters and detectors, and/or infrared light emitters and detectors. The pulse of light mentioned above can be a constant pulse or can be modulated at a carrier frequency to distinguish it from background light sources.

If a carrier frequency is used by emitters, a plurality of different frequencies can be selectively used to distinguish between light pulses originating from a plurality of different portable gaming systems, the software detecting and differentiating among the different frequencies to determine which of a plurality of gaming systems fired a particular pulse of light received by a detector. In addition to different frequencies, different amplitudes and durations can be used to encode information within pulses of light about the source of origin (i.e. which portable gaming system of a plurality of portable gaming systems) and/or what simulated weapon was used when the pulse was generated.

Other methods can be used instead of, or in addition to, the light emitter/detector method of determining if weapons fire hits targets. In some methods the images from the cameras connected to the portable gaming systems are used to determine the targeting of weapons. In other methods data from GPS and magnetometer sensors are used to determine the position and orientation of the portable gaming systems and thereby determine the direction of fire of a firing system as well as the location of potential targets (i.e. other portable gaming systems). In some embodiments these methods are used in combination, using data from emitter/detector pairs, cameras, and GPS sensors in combination to determine the directions of weapons fires and whether or not such weapons successfully hit other portable gaming systems and/or simulated targets.

In many embodiments of the current invention speakers or headphones are included upon the portable gaming system that are controlled by software to create sound effects that correspond with gaming action within the real/simulated playing field. For example if a player fires a weapon at a real target (i.e. another player) or a simulated target (i.e. a computer generated entity), a sound effect is generated by the software running upon the portable gaming system of that player and displayed through the speakers (and/or headphones). In addition graphical images are displayed upon the screen of the portable gaming system to correspond with the weapons fire. Similarly if a player is hit by a weapon as determined by the light sensor method described above, or some other method, the software running upon the portable gaming system of the player that was hit by the weapon creates and plays a sound effect associated with the weapon hit. For example an explosion sound is generated and played by the portable gaming system when the portable gaming system is determined to have been hit by a weapon fired by another portable gaming system. The form, magnitude, and/or duration of the explosion based upon the intensity of the simulated hit and/or controlled based upon which of a plurality of simulated weapons were used by the portable gaming system that fired the weapon. In other examples a player of a portable gaming system might be hit by a simulated weapon (a weapon fired not by another player but by a simulated entity within the merged real/simulated space). Upon being hit by the weapon, the portable gaming system of the player plays a simulated sound effect on the speakers (and/or headphones) of the portable gaming system, the form and/or magnitude and/or duration of the sound effect being modulated based upon the intensity of the hit and/or the type of simulated weapon that was fired. In addition graphical images are displayed upon the screen of the portable gaming system to correspond with the weapons hit.

It is important to note that the weapons mentioned in the examples above need not be violent weapons that cause things to explode but can be more abstract as moderated by the gaming software. For example a player can select a weapon from a pool of simulated weapons by using the user interface controls upon his or her portable gaming system. The weapon he or she might choose might be a “tomato gun” that shoots a simulated stream of tomatoes at an opponent. This may cause a graphical display of a smashed tomato being overlaid upon the real video captured from that player's camera. In this way simulated computer generated effects can be merged with real physical action to create a rich on-screen off-screen gaming experience.

With respect to the example above, the player might choose other weapons through the user interface upon the portable gaming system—for example, he or she might choose might be a “blinding light gun” that shoots a simulated beam of bright light at an opponent. This may cause a graphical display of a bright beam of light being overlaid upon the real video captured from that player's camera. Depending upon sensor data used to determine targeting, it may be determined in software if the blinding light beam hit the opponent who was aimed at. If the opponent was hit, the simulated blinding light weapon causes the visual feedback displayed on the screen of that player to be significantly reduced or eliminated all together. For example, the player's video feedback from his camera could turn bright white for a period of time, effectively blinding the player of his or her visual camera feedback for that period of time. In this way simulated computer generated effects can create a rich on-screen off-screen gaming experience.

The Portable Gaming System Hardware

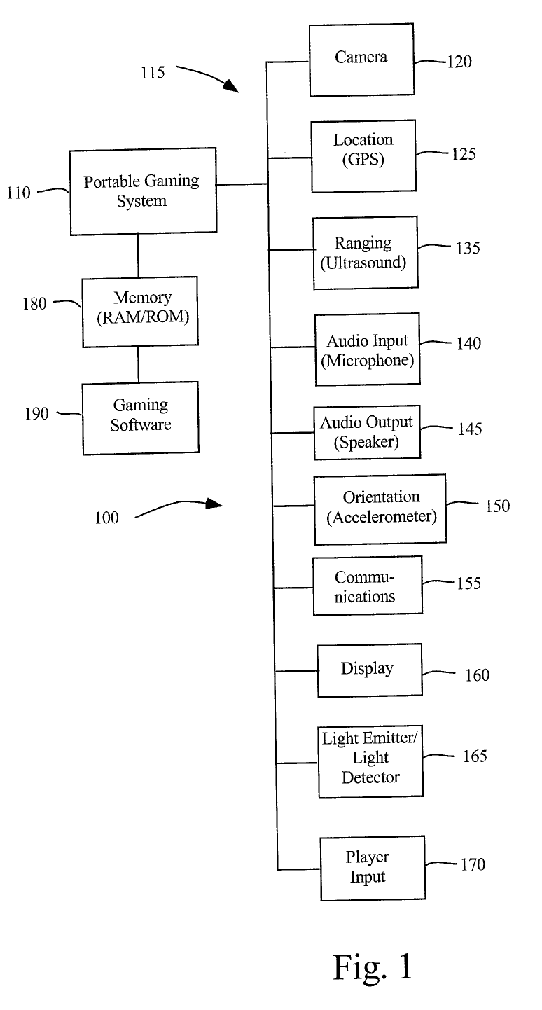

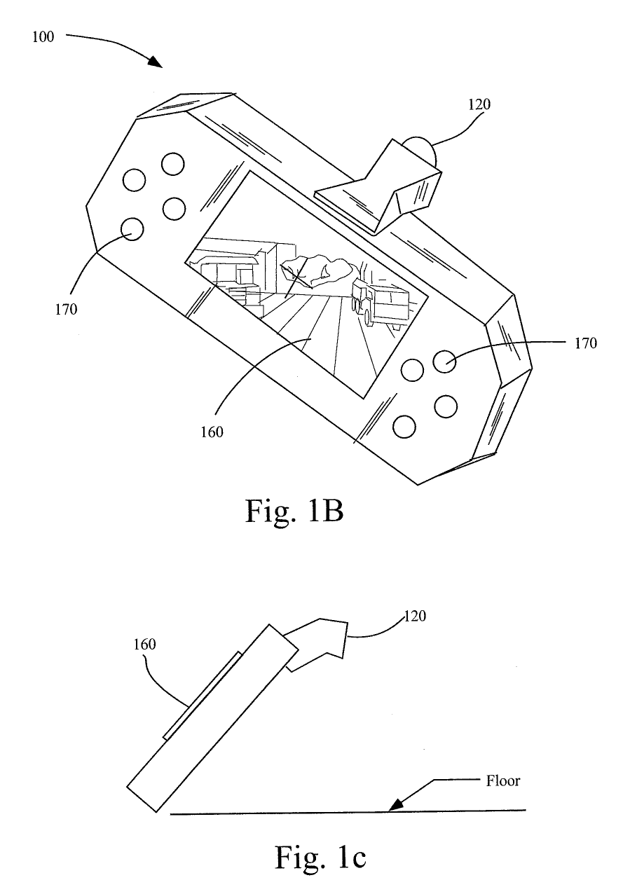

Now referring to FIG. 1, a systems diagram 100 of the portable gaming system 110 is shown.

A portable gaming system 110 is equipped with a camera 120, a location sensor or GPS 125, a ranging sensor 135, an audio input subsystem 140, an audio output subsystem 145, an orientation subsystem 150, a communications subsystem 155, a display 160, a light emitter/detector pair 165, and a user input 170. The portable gaming system 110 is also equipped with a memory subsystem 180 which loads and stores the gaming software 190.

The controlling subsystem on the portable gaming system 110 is a game central processor unit (not shown). The game central processor unit computer (not shown) is connected to a memory subsystem 180. The memory subsystem 180 stores the gaming software 190.

a) Camera

The controlling subsystem on the portable gaming system is connected to the camera 120 via bus or serial interface. The camera 120 is preferably digital, but analog implementations with digitizers may be used. The sampling rate of the camera should be set to capture and digitize images at a rate to provide a video experience (approx >30 frames per second).

The camera 120, as shown in FIGS. 1B and 1C, the camera 120 is affixed to the portable gaming system 110 such that it points away from the user. The camera 120 is attached such that the user can view the display 160 on the back of the portable game system 110 while aiming the camera forward into the real physical space within which the game is being played. As shown the camera points away from the user. Also shown is the unique angle at which the camera is affixed to the portable gaming system 110 such that the display 160 can be tilted forward at an angle of approximately 60 degrees from vertical and the camera 120 is then level with respect to the floor. This allows the user to view the display 160 conveniently while walking about the real physical space, the camera held at an approximately level angle when the display is tilted forward at approximately 60 degrees from vertical to allow convenient viewing. By convenient viewing it is meant that the user can hold the portable gaming system 110 at a comfortable height before him or her, tilted forward such that the display is clearly visible without the portable gaming system significantly blocking the user's direct visual sight of the physical space. In some embodiments other angles can be forward of vertical to achieve a similar visual effect, although 60 degrees is currently the preferred angle. Also some embodiments can allow a user-adjustable angle such that the angle is automatically detected by a sensor in the connection between the camera 120 and the portable gaming system 110 or such that the angle is automatically sensed by calibrating the camera image with respect to the floor level or other horizontal or vertical reference. In some embodiments a tilt sensor is used to sense the orientation of the camera 110 with respect to the real physical space and update the gaming software 190 accordingly.

b) Location Sensor

The controlling subsystem on the portable gaming system 110 is connected to the location sensor 125 via a bus or serial interface. The location sensor provides a set of coordinate data to the portable gaming system 110 to be utilized by the gaming software 190.

The location sensor 125 may be implemented using a GPS sensor data, accelerometer data, Navigation Chip data, and/or a combination of those technologies to determine location.

A GPS sensor is easily implemented using standard off the shelf GPS systems with computerized interfaces. These devices are well known in the arts and easily implemented.

An accelerometer is affixed to the portable gaming system, the motion of the portable gaming system cause by the user carrying the portable gaming system as described herein causing data from the accelerometer to be updated. For example if the user takes a step forward holding the portable gaming system with an accelerometer affixed, a forward acceleration is recorded in data from the accelerometer. The magnitude and profile of the acceleration can be used to update the overlaid graphical image displayed upon the portable gaming system upon the image of the graphics. For example, the acceleration data is integrated over time, twice, to produce velocity data for the portable gaming system the velocity data can be integrated over time to produce distance traveled of the portable gaming system. The another way the acceleration data is integrated over time, twice, yielding position change data from the acceleration data. The position change data being used by the software running upon the portable gaming system to update the gaming action (and thereby update the graphical overlaid images upon the camera image). In some embodiments the change in camera images over time is processed by software upon the portable gaming system to determine motion traveled by the portable gaming system as a result of the user carrying the system as described herein

An alternative sensing method that is inexpensive and accurate is a method of tracking the location, motion, and orientation of a portable gaming system as it is moved about a physical space. This sensing method uses one or more optical position sensors. Such sensors, as commonly used in optical computer mice, takes optical pictures of that surface at a rapid rate (such as 1500 pictures per second) using a silicon optical array called a Navigation Chip. Integrated electronics then determine the relative motion of the captured image with respect to the sensor. As described in the paper “Silicon Optical Navigation” by Gary Gordon, John Corcoran, Jason Hartlove, and Travis Blalock of Agilent Technology (the maker of the Navigation Chip), the paper hereby incorporated by reference, this sensing method is fast, accurate, and inexpensive. For these reasons such sensors are hereby proposed in the novel application of tracking the changing position and/or orientation of a portable gaming system as it is carried about by a user. In this embodiment the Navigation Chip is aimed outward toward the room in a direction similar to the camera mentioned previously. This chip takes rapid low resolution snapshots of the room the way a camera would and uses integrated electronics to compute the relative motion (offset) of the snapshots very quickly. Because it is assumed that the room itself is stationary and the portable gaming system is moving, the motion between snapshots (i.e. the offset) can be used to determine the relative motion of the portable gaming system over time (changing position and/or orientation). Multiple of the Navigation Chips can be used in combination, each mounted at a different location and/or aimed in a different direction, to get more accurate change information.

c) Ranging Sensor

The controlling subsystem on the portable gaming system 110 is connected to the ranging sensor 135 via a bus or serial interface. The ranging sensor 135 is typically a device which can measure short distances (approx 0-30 ft) using ultrasound (e.g. sonar). Typical sonar sensors may be the Polaroid 600 and 9000, the Massa E152/40, Sonaswitch Mini-A, and Devantech SRF04. Other technologies, such as infared ranging may also be located on the portable gaming system 110.

d) Audio Input

The controlling subsystem on the portable gaming system 110 is connected to a audio input 135 via a bus or serial interface. The signal from the audio input device, usually a microphone, is digitized and used by the portable gaming system 110.

e) Audio Output

The controlling subsystem on the portable gaming system 110 is connected to an audio output 135 via a bus or serial interface connected to a digital to analog converter with amplification output circuitry. The audio output 135 may be connected to a speaker (not shown) or headphones (not shown) connected to a headphone jack on the portable gaming system 110.

f) Orientation Subsystem

The controlling subsystem on the portable gaming system 110 is connected to the orientation subsystem 150 via a bus or serial interface. The orientation subsystem can be configured to determine changes of the portable gaming system within the X-Y-Z axis. The orientation subsystem 150 may be implemented using an accelerometer that detects the change in position. Alternately the orientation subsystem 150 may be implemented using a magnetometer.

g) Communications Subsystem

The controlling subsystem on the portable gaming system 110 is connected to the communications subsystem 155 via a bus or serial interface.

The communications subsystem 155 may be implemented using well know technologies, such as, Wi-Fi (TM Wifi Alliance—www.wi-fi.org), Bluetooth (TM Bluetooth SIG—www.bluetooth.org), or connectivity using infra red or WLAN.

A bidirectional communication channel can be established between a plurality of portable gaming systems, said communication connection for transmitting data, said data including score data and/or spatial position data and/or spatial layout data and/or simulated object data. In some embodiments each of said portable gaming systems 110 is identifiable by a unique ID included in said data.

Also, in some embodiments one or more portable gaming systems communicate with a stationary gaming console that is connected to a TV or a stationary personal computer running gaming software.

Also, in some embodiments for certain appropriate features, for example analog radio frequency communication can be used to convey camera images from one portable gaming system to another.

h) Display

The controlling subsystem on the portable gaming system 110 is connected to the screen 160 via a bus interface. The screen 160 may be implemented using LCD technology and have a form factor that is integrated within the portable gaming system 110.

i) Light Emitting/Light Detecting Pair

The controlling subsystem on the portable gaming system 110 is connected to the light emitting/light detecting pair 165 via a bus or serial interface. The light emitting/light detecting pair 165 is implemented using a variety of technologies.

In one embodiment the emitter is infra-red light source such as an LED that is modulated to vary it's intensity at a particular frequency such as 200 HZ. The detector is an infra-red light sensor affixed to the portable gaming system such that it detects infra-red light that is directionally in front of it. In this way the user can move about, varying the position and orientation of the portable gaming player as he moves, thereby searching for an infra-red light signal that matches the characteristic 200 Hz modulation frequency.

A variety of different frequencies can be used upon multiple different objects within the physical space such that the sensor can distinguish between the multiple different objects. In addition to targets, beacons and barriers can be used to guide a user and/or limit a user, within a particular playing space. In addition to targets, beacons, and barriers, other portable gaming systems can be detected using the emitter/detector pair method disclosed herein. For example if a plurality portable gaming systems are used in the same physical space as part of the same game action, each could be affixed with an emitter (ideally on top such that it was visible from all directions) and a sensor (ideally in front such that it can detect emitters that are located in front of it).

j) Player Input

The controlling subsystem on the portable gaming system 110 is connected to the player input 170 via a bus or serial interface. The player input 170 may be implemented using a set of switches. These switches provide signals to the gaming software 190 via the controlling subsystem on the portable gaming system 110. An exemplary portable gaming system, as depicted in [R-FIG. 1], the portable gaming system consists of two sets of four switches, each switch positioned beneath where the thumb, the thumb being able to depress the switch. Other portable game systems may use different switch configurations, touchscreens, or joystick control.

K) Physical Implementations of the Portable Gaming System

An alternate inventive embodiment that can be combined with many of the inventive methods and apparatus disclosed herein employs a portable gaming system that is worn by the player rather than carried in the hands of the player as the player moves about the real physical space.

In one such worn embodiment the portable gaming system 110 is worn on the wrist of the player with the display of the portable gaming system 110 orientated upward away from the wrist similar to how the display of a wristwatch is oriented when worn (although the size of the display may be larger than a traditional wristwatch).

In one embodiment of the wrist worn portable gaming system 110, a camera 120 is affixed to the portable gaming system such that when the user positions his or her wrist for convenient viewing of the display (similar to way a person positions his or her wrist for convenient viewing of a wristwatch) the camera 120 is oriented such that it points away from the user, forward and level into the real physical space that the player is facing. In this way the player can glance down at the worn portable gaming system on his or her wrist the way a player would glance down at a watch worn on the wrist and view a displayed video image of the real physical space the player is facing as captured by the camera, the video image displayed upon the screen of the portable gaming is displayed along with simulated graphical content that is overlaid upon the video image as described previously herein.

The player can use the wrist worn portable gaming system to target, select, fire upon, and/or otherwise engage real physical locations and/or real physical objects in a combined on-screen off-screen gaming experience.

Operation of Multiple Gaming Systems

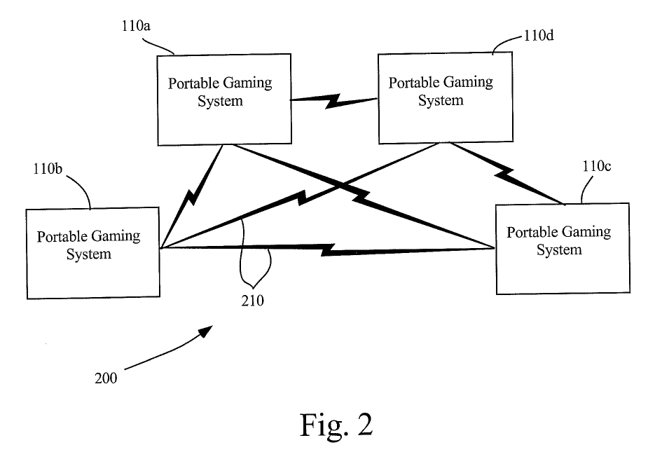

Now referring to FIG. 2, the interaction of multiple gaming systems 200 are depicted. Four portable gaming systems 110-A, 110-B, 110-C, and 110-D each have wireless interfaces (not shown). Each wireless interface establishes a communication link 210 with another portable gaming system when the two systems are within proximity of each other.

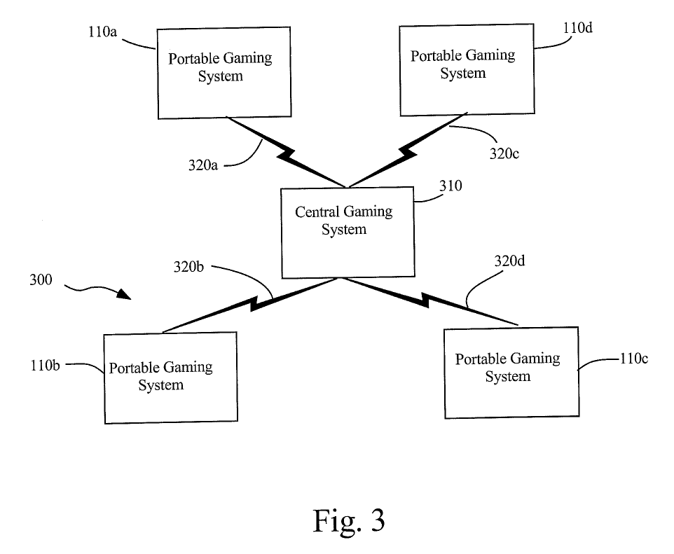

Now referring to FIG. 3, an alternate configuration of the multiple gaming systems 300 is shown. Four portable gaming systems 110a, 110b, 110c, and 110d each have wireless interfaces (not shown). A central gaming system 310 is configured to send and receive messages via a wireless channel. Each wireless interface establishes a communications link 320a, 320b, 320c, and 320d with the central gaming system 310.

Software Operation of the Portable Gaming System

As described earlier the controlling subsystem on the portable gaming system 110 is a game central processor unit (not shown). The game central processor unit computer (not shown) is connected to a memory subsystem 180. The memory subsystem 180 stores the gaming software 190. The gaming software 190 executes and controls each of the subsystems as shown in FIG. 1, and interacts with other portable gaming systems 110-a, etc as shown in FIG. 2 and FIG. 3.

During operation of the portable gaming system 110, software routines are executed that provide a rich on-screen/off-screen experience.

a) Multiplayer Synchronization

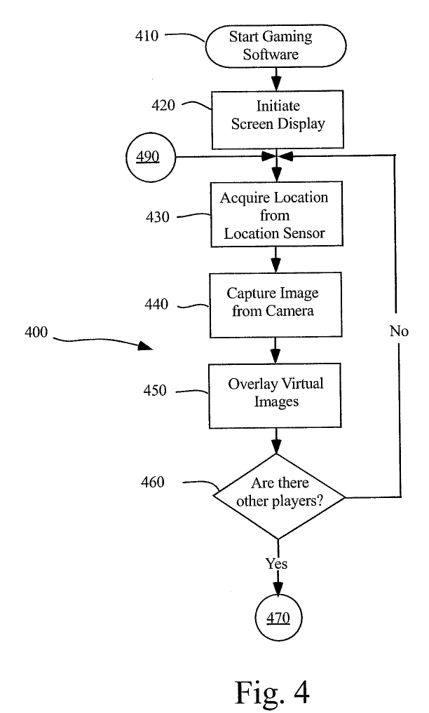

Now referring to FIG. 4, a flowchart 400 of the software initialization process is shown. After the portable gaming system 110 has started, the gaming software is loaded 410 into memory and executed. The screen display 160 is loaded from memory 420. In the next step 430 acquires the current location of the player from the location sensor 125. In the next step 440, an image is captured using the camera 120 and stored in memory. The next step 450 overlays virtual image content upon the camera image and displays the resulting composite image on the display 160. In the next step 460, other players are polled using the communications 155 interface.

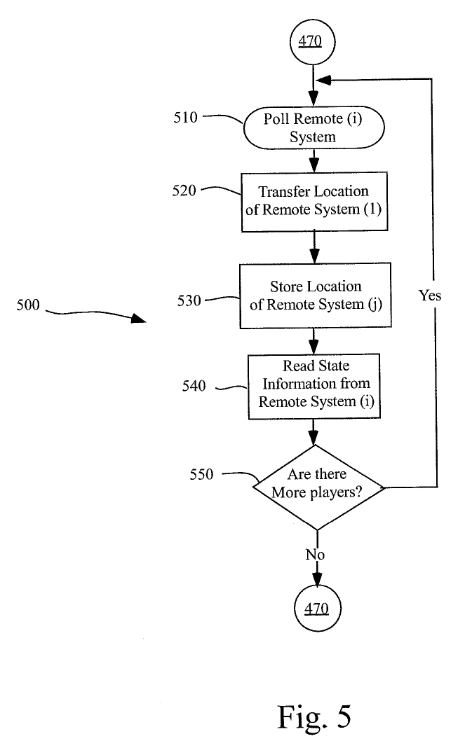

Now referring to FIG. 5, in the first step 510, each remote system is sequentially polled to determine if it is within communications range. The actual location of the remote system is transferred 520 to the player's the portable gaming system 110. The GPS coordinates of the remote system is stored 520 in the portable gaming system 530. The state information of the remote system 540 is read and loaded into the portable gaming system 110. This state information is used by the gaming software 190 in the course of interactive playing. The cycle repeats 550 until all of the portable gaming systems have been queried. This frequency of repetition is enough to provide a user with “real-time” experience.

b) Real and Virtual Image Integration

Now referring back to FIG. 4, a real-time image is captured 440 using the camera 120 and integrated with virtual images 450 that are stored in the gaming software 190. The gaming software 190 performs a number of functions to enhance the on-screen/off-screen experience.

c) Real and Simulated Functions

As described in the paragraphs above, the playing field engaged by the user is a merged real/physical space that has both real and simulated features and functions. This is achieved by running a gaming simulation aboard a portable gaming systems 110 the gaming simulation being updated in response to the user carrying the portable gaming systems to varying locations and/or orientations within a real physical space. The gaming simulation may also be updated in response to other users carrying other portable gaming systems 110 to varying locations and/or orientations within the real physical space.

The gaming simulation also being updated in response to the player input 170 (or other manual controls) upon the portable gaming system that he or she is carrying to different locations and/or orientations within the real physical space. The gaming simulation may also being updated in response to other player's input (or other manual controls) upon the other portable gaming systems that they are carrying to different locations and/or orientations within the real physical space. In many embodiments a camera is connected to the portable gaming system of the user, the camera 120 aimed to away from the user such that it captures changing video images of the real physical space with a substantially first person perspective as the portable gaming system is carried about the real physical space. The changing video images are displayed in real time upon the display 160 of the portable gaming system, depicting the player's then current position and orientation within the real physical space.

Computer generated images are also produced by the gaming software 190 running upon the portable gaming system 110 and are displayed along side and/or overlaid upon the changing video images. The computer generated images include text, numbers, and graphics that depict changing simulated features and functions of the playing space along with the changing video images of the playing space as the user carries the portable gaming system about the real physical space. In this way, simulated features and functions are combined with the real-world experience by the gaming software running upon the portable gaming system 110.

The simulated functions also expand upon the gaming scenario, creating simulated objectives and simulated strategy elements such as simulated power consumption, simulated ammunition levels, simulated damage levels, simulated spatial obstacles and or barriers, and simulated treasures and/or other simulated destinations that must be achieved to acquire points and/or power and/or ammunition and/or damage repair.

The simulated functions can include simulated opponents that are displayed as overlaid graphical elements upon or within or along side the video feedback from the real-world cameras. In this way a player can interact with real opponents and/or real teammates in a computer generated gaming experience that also includes simulated opponents and/or simulated teammates.

The phrase “simulated player” is meant to refer to the combined real-world capabilities of the player to move about the real physical space combined with the simulated features and functions introduced into the gaming scenario by the gaming software. In this way the “simulated player” is what the user experiences and it is a merger of the features and functions of both the real world physical space and the simulated computer gaming content.

ii) Simulated Lighting Conditions

One method enabled within certain embodiments of the present invention merges simulated gaming action with real-world action by adjusting the display of visual feedback data received from the camera based upon simulated lighting characteristics of the simulated environment represented within the computer generated gaming scenario. For example, when the gaming software 190 is a simulating a nighttime experience, the display of visual feedback data from the camera is darkened and/or limited to represent only the small field of view illuminated by simulated lights proximate to the simulated player.

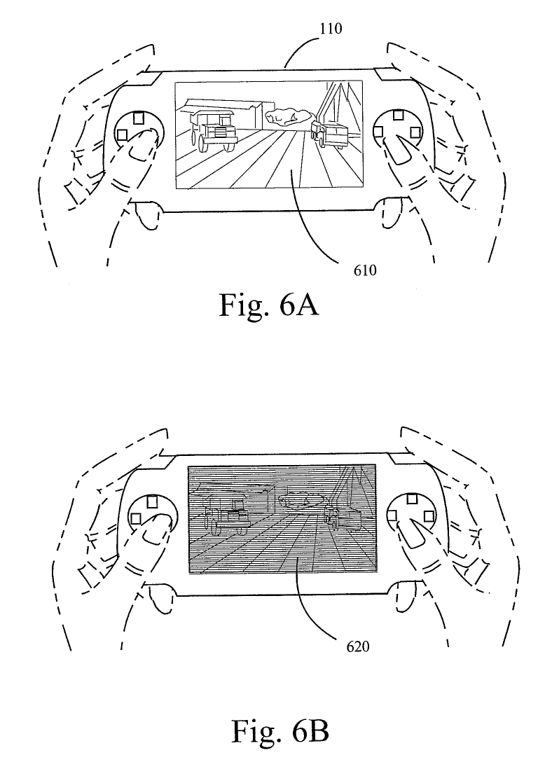

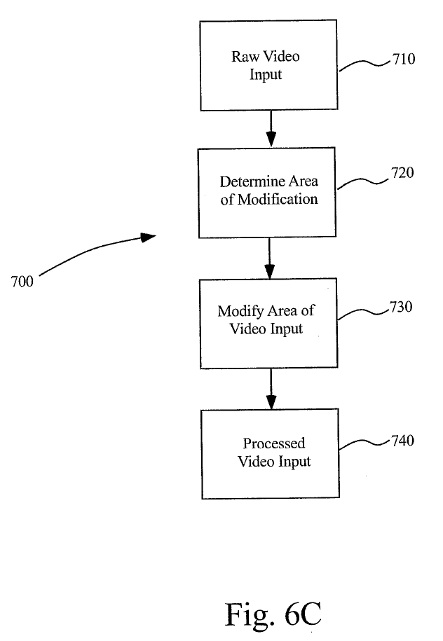

Now referring to FIG. 6A a portable gaming system 110 is shown showing the raw camera footage 610 displayed upon a portable gaming device 110 as received from the camera 120 (not shown).

Now referring to FIG. 6B a portable gaming system 110 is shown displaying the camera images as modified by gaming software 190 such that it is darkened to represent a simulated nighttime experience 620.

Alternatively (not shown) the same camera images 120 could be modified by gaming software 190 such that it is darkened and limited to a small illuminated area directly in front of the player to represent a nighttime scene that is illuminated by simulated lights near to the simulated player.

Now referring to FIG. 6C, the method 700 by which an image can be processed consists of taking the raw video input from the camera 710, determine the area of modification 720 based on parameters set by the gaming software 190, modify the area of input 730 (either darkening, lightening, or tinting) to correspond with simulated lighting conditions, and storing the processed image 740 to be used by the gaming software 740.

In another embodiment the image displayed upon the portable gaming system is tinted red to simulate a gaming scenario that takes place upon the surface of mars. As another example the image displayed upon the portable gaming system is tinted blue to simulate an underwater gaming experience. In these ways the simulated game action moderates gaming action, merging computer generated gaming scenarios with physical action to create a rich on-screen off-screen gaming experience.

iii) Simulated Terrain and/or Backgrounds

Another embodiment merges simulated gaming action with real-world user motion about a real physical space by merging of computer generated graphical images with the real-world visual feedback data received from the camera to achieve a composite image representing the computer generated gaming scenario.

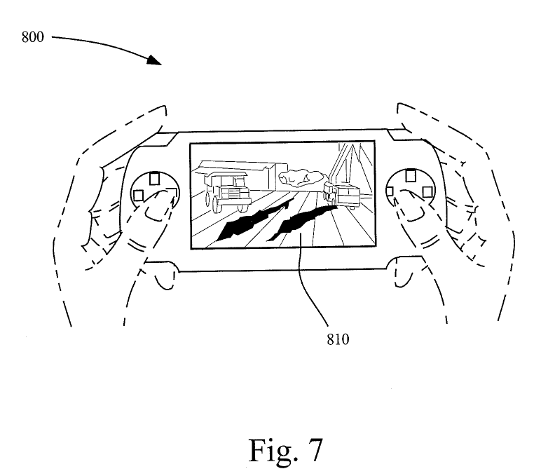

Now referring to FIG. 7 a player is holding a portable gaming system 110 with a captured image 800. The computer generated gaming scenario is a simulated world that is devastated by an earthquake. To achieve a composite image representing such a computer generated scenario the display of visual feedback data from the remote camera is augmented with graphically drawn earthquake cracks in surfaces such as the ground, walls, and ceiling 810.

Other simulated terrain images and/or background images and/or foreground objects, targets, opponents, and/or barriers can be drawn upon or otherwise merged with the real-world video images. In this way simulated game action moderates the physical play, again merging computer generated gaming scenarios with physical motion about the real space to create a rich on-screen off-screen gaming experience.

iv) Simulated Weapons

Another method enabled within certain embodiments of the present invention merges simulated gaming action with real-world player motion about a real physical place by overlaying computer generated graphical images of weapon targeting, weapon fire, and/or resulting weapon damage upon the real-world visual feedback data received from the camera 120 to achieve a composite image representing the computer generated gaming scenario.

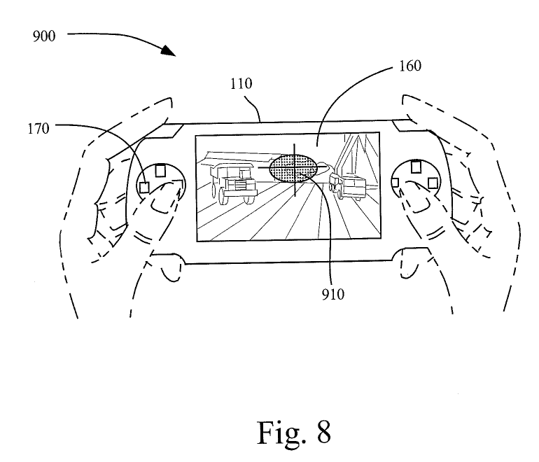

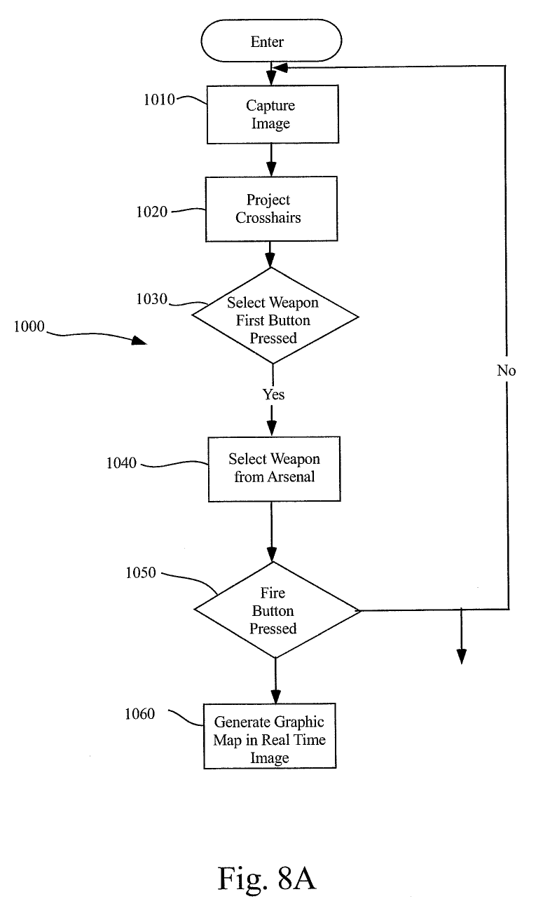

Now referring to FIG. 8, a portable gaming system 110 is shown held by a player with the camera aimed at an image 900. The camera captures the image and projects it on the display 160.

The computer generated gaming scenario provides the player with simulated weapon capabilities. To enable targeting of the weapon within the real-world scene a graphical image of a targeting crosshair 910 is generated by the gaming software on the portable gaming system 110 and displayed as an overlay upon the real world video images received from the camera.

Now referring to FIG. 8A, the method of targeting and firing is shown in the following flowchart 1000. As the player moves about the real physical space, carrying his or her portable gaming system, the video image pans across and/or moves within the real world scene 1010. As the video image moves, the cross hairs target different locations within the real world space 1020. In the example of FIG. 8 the camera is pointed in a direction such that the targeting crosshair is aimed upon the beanbag in the far corner of the room.

The player may choose to fire upon the beanbag by pressing an appropriate player input 170 upon the portable game system 110. A first button press selects an appropriate weapon from a pool of available weapons 1030. For example, the player selects a laser beam weapon 1040.

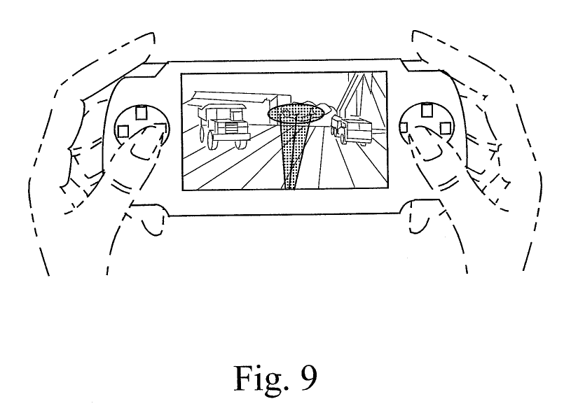

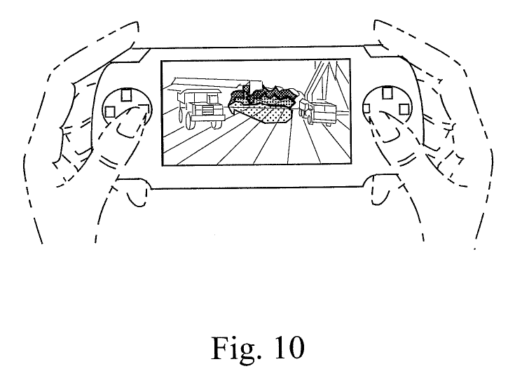

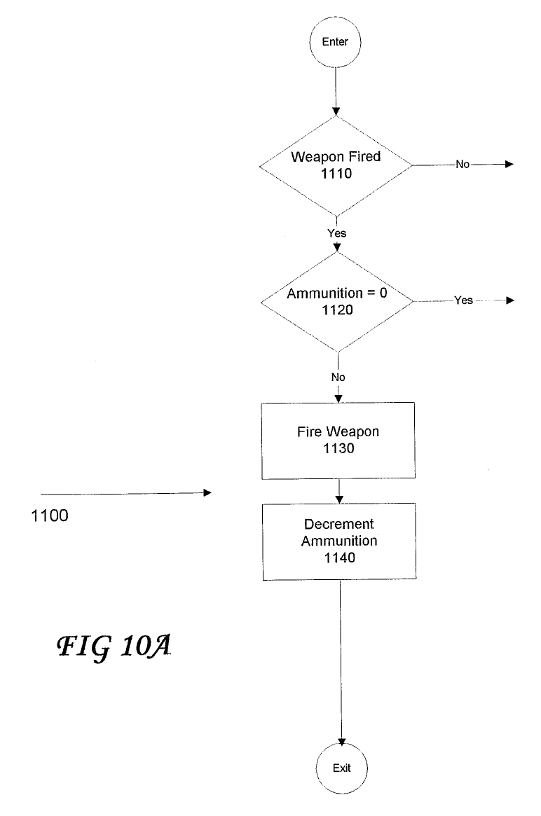

A second button press fires the weapon at the location that was targeted by the cross hairs 1050. Upon firing the gaming software running upon the portable gaming system generates and displays a graphical image of a laser beam overlaid upon the real-world image captured by the camera 1060. The overlaid image of the laser weapon may appear as shown in FIG. 9 and would be accompanied by an appropriate sound effect. This overlaid computer generated laser fire experience is followed by a graphical image and sound of an explosion as the weapon has its simulated effect upon the merged real/physical space. When the explosion subsides, a graphical image of weapon damage is overlaid upon the real-world video image captured by the camera. An example of an overlaid weapons damage image is shown below in FIG. 10. In this way simulated game action is merged with real world physical motion about a space to create a rich on-screen off-screen gaming experience through a portable gaming system. For example the firing of weapons is moderated by both the real-world position and orientation of the player within the space AND the simulation software running upon the portable gaming system.

As shown in FIG. 10A a method by which the simulated gaming action running as software upon the portable gaming system can moderate combined on-screen off-screen experience of the player is through the maintenance and update of simulated ammunition levels. To enable such embodiments the gaming software 190 running upon the portable gaming system 110 stores and updates variables in memory representing one or more simulated ammunition levels, the ammunition levels indicating the quantity of and optionally the type of weapon ammunition stored within or otherwise currently accessible to the simulated vehicle.

When the gaming software 190 running upon the portable gaming system fires a weapon 1110, the gaming software 190 determines whether the ammunition level is at ‘0’ 1120. If the ammunition level is not at ‘0’ the simulated player can fire a particular weapon at a particular time 1130. Once the weapon is fired the ammunition is decremented for that particular weapon 1140. In this way the firing of weapons is moderated by both the real-world position and orientation of the player and the simulation software running upon the portable gaming system.

The word “weapon” as described above is used above need not simulate traditional violent style weapons. For example, weapons as envisions by the current invention can use non-violent projectiles including but not limited to the simulated firing of tomatoes, the simulated firing of spit balls, and/or the simulated firing of snow balls. In addition, the methods described above for the firing of weapons can be used for other non-weapon related activities that involve targeting and/or firing such as the control of simulated water spray by a simulated fire-fighting players and/or the simulated projection of a light-beam by a flashlight wielding player.

v) Simulated Power Levels and/or Damage levels

Another method enabled within certain embodiments of the present invention merges simulated gaming action with real-world player motion about a physical space by moderating a players's simulated capabilities within the real physical space based upon simulated fuel levels, power levels, and/or damage levels.

To enable such embodiments the gaming software running upon the portable gaming system stores and updates variables in memory 180 representing one or more simulated fuel levels, power levels, and/or damage levels associated with the player. Based upon the state and/or status of the variables, the gaming software 190 running upon the portable gaming system 110 modifies how a player's input 170 (as imparted by the player moving about the real physical space and/or by manual player interface on the portable gaming system) are translated into gaming action. For example, if the simulated damage level (as stored in one or more variables within the portable gaming system 110) rises above some threshold value, the software running on the portable gaming system may be configured to limit the capabilities of the simulated player as the player moves about the real physical space.

In another embodiment, when the damage level rises above some threshold value, certain capabilities of the simulated player such as firing weapons, shining lights, using simulated radar, viewing camera images upon the display, are limited and/or eliminated for some period of time by the software running upon the portable gaming system.

vi) Simulated Shields

Another embodiment that merges simulated gaming action with real-world player motion about a real physical space through the generation and use of simulated shields to protect the simulated player from weapons fire and/or other potentially damaging simulated objects. To enable such embodiments the gaming software running upon the portable gaming system 110 stores and updates variables in memory representing one or more simulated shield levels (i.e., shield strengths) associated with the player. Based upon the state and/or status of the shield variables, the gaming software running upon the portable gaming system 110 modifies how simulated damage is computed for the player when the player, based upon his then current location with the real physical space, is hit by weapons fire and/or encounters or collides with a simulated object that causes damage. In this way the imparting of damage is moderated by simulated gaming action.

Furthermore the presence and/or state of the simulated shields can effect how the player views the real camera feedback and/or real sensor feedback from the real world. For example, in some embodiments when the shields are turned on by a player the camera feedback displayed to that player is degraded as displayed upon the portable gaming system 110. This computer generated degradation of the displayed camera feedback represents the simulated effect of the camera 120 needing to see through a shielding force field that surrounds the player. Such degrading can be achieved by distorting the camera image, introducing static to the camera image, blurring the camera image, reducing the size of the camera image, adding a shimmering halo to the camera image, reducing the brightness of the camera image, or otherwise degrading the fidelity of the camera image when the simulated shield is turned on. This creates additional gaming strategy because when the shield is on the player is safe from opponent fire or other potentially damaging real or simulated objects, but this advantage is countered by the disadvantage of having reduced visual feedback from the cameras as displayed upon the portable gaming system 110.

vii) Simulated Terrain Features, Barriers, Force Fields, and Obstacles

Another embodiment merges simulated gaming action with real-world player motion about a physical space by displaying upon the screen of the portable gaming system 110, simulated terrain features, simulated barriers, simulated force fields, and/or other simulated obstacles or obstructions. To enable such embodiments the gaming software 190 running upon the portable gaming system 110 stores and updates variables in memory representing one or more simulated terrain features, simulated barriers, simulated force fields, and/or other simulated obstacles and/or obstructions. The variables can describe the simulated location, simulated size, simulated strength, simulated depth, simulated stiffness, simulated viscosity, and/or simulated penetrability of the terrain features, barriers, force fields, and/or other simulated objects. Based upon the state and/or status of the variables and the location and/or motion of the player motion about the real physical space, the gaming software running upon the portable gaming system 110 selectively displays the terrain features, barriers, force fields, and/or other simulated objects and updates the gaming action accordingly. In some embodiments, the simulated terrain features, simulated barriers, simulated force fields, and/or other simulated objects are drawn by the software running on the portable gaming system 110 and overlaid upon the real video imagery from the camera.

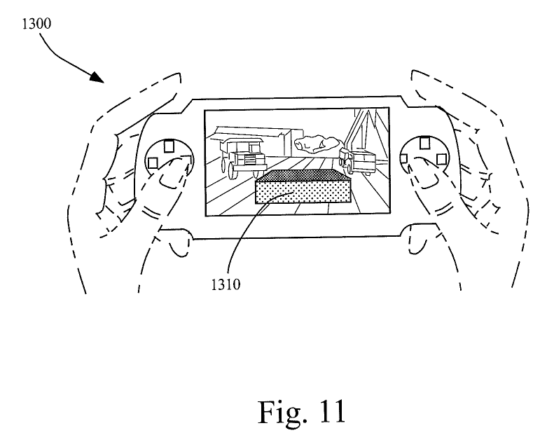

Now referring to FIG. 11, a barrier is shown as a graphical overlay simulating a barrier 1310 displayed upon the real video feedback from the camera 1300. In some embodiments, if the player tries to walk past the barrier 1310, the player will be penalized within the game as computed by the gaming software running upon the portable gaming system 110—for example the software running upon the portable gaming system 110 may impose simulated damage upon the player and/or subtract points from the player and/or subtract simulated power from the player and/or subtract simulated ammunition from the player and/or subtract remaining playing time from the player in response to the player moving into, onto, and/or past the simulated barrier within the real/simulated playing space.

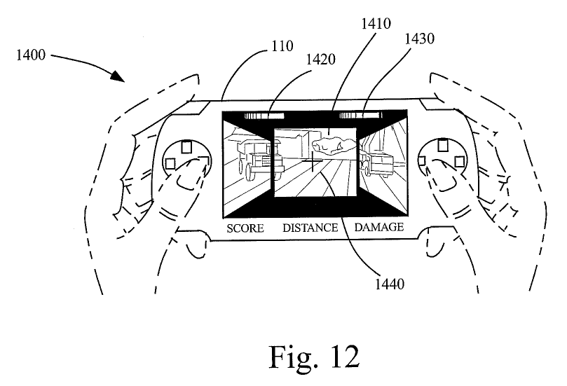

Now referring to FIG. 12, a portable gaming system 110 displaying live real-time video from a camera mounted upon the portable gaming system 1400. The video combined with overlaid graphical imagery showing a cockpit view 1410 of a simulated vehicle, the simulated vehicle being controlled by the player to engage the gaming action. The motion of the simulated vehicle being controlled by the player by carrying the portable gaming system 110 about the real physical space.

For example, as the player walks forward through the real physical space he is given the illusion that the simulated vehicle is flying forward through that space because the video image changes perspective appropriately with respect to the fixed image of the drawn cockpit of the simulated vehicle. In addition the simulated gaming action is updated consistent with the vehicle moving forward. Similarly as the player turns within the real physical space he is given the illusion that the simulated vehicle is turning within the real physical space because the video image changes perspective appropriately with respect to the drawn cockpit of the simulated vehicle.

In addition the simulated gaming action is updated consistent with the vehicle turning within the real/simulated playing environment. The red bar 1420 along the top of the display is a fuel meter and is currently reading a full tank of simulated fuel for the simulated vehicle. The green bar 1430 along the top of the display is an ammunition meter and is currently reading full load of simulated ammunition stored within the simulated vehicle. The crosshair 1440 in the center shows the simulated targeting location of a simulated weapon of the simulated vehicle with respect to the real environment.

viii) Gaming Scores

Another embodiment is the computer generated gaming score and/or scores, as computed by the gaming software 190 running upon the portable gaming system 110, are dependent upon the simulated gaming action running upon the portable gaming system 110 as well as real-world motion of the player about the real physical space.

As described previously, scoring can be computed based upon the imagery collected from a camera and/or sensor readings from other sensors connected to the portable gaming system. For example, scoring can be incremented, decremented, or otherwise modified based upon the player contacting or otherwise colliding with simulated objects within the combined real/simulated playing field. This can be achieved by the player stepping forward and thereby carrying the portable gaming system 110 to a location such that it comes within some distance of and/or lands upon the location of a simulated object within the combined real/simulated playing field. For example, a player might be standing at a location within the real physical world, holding the portable gaming system 110 at a particular location and orientation.

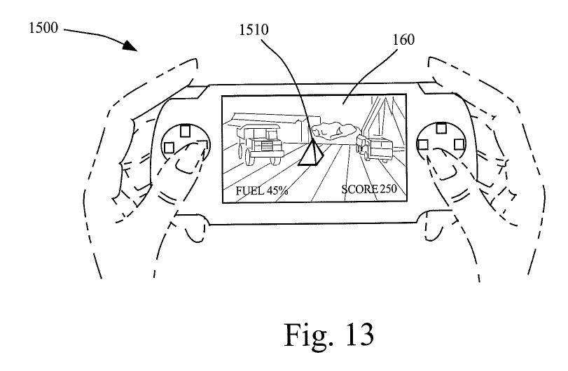

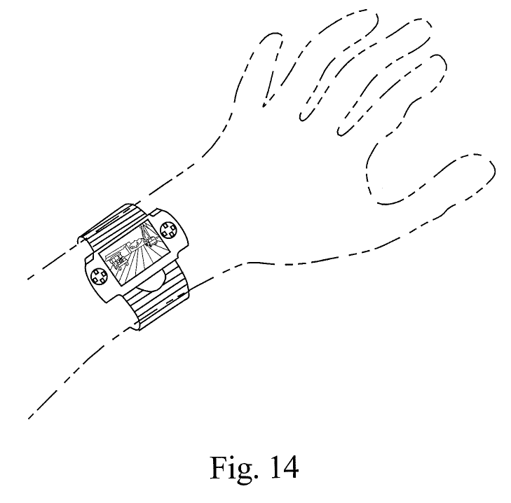

Now referring to FIG. 13, the camera 120 attached to the portable gaming system 110 provides a real video image of the real world as held by the player.

The screen 160 depicts an image including a room, a bed, a beanbag, toy car, and other real world objects. In addition the gaming software 190 running upon the portable gaming system 110 creates a simulated object at a location five feet in front of the player, the simulated object being a treasure the player must acquire to receive points, the simulated object 1510 drawn as a graphical overlay upon the video image by gaming software running upon the portable gaming system 110.

As shown in FIG. 13 the simulated object 1510 is drawn as a graphical pyramid that is overlaid at a location upon the video image as shown. If the player takes a step forward, thereby changing the location of the portable gaming system 110 that he or she is carrying with respect to the real physical world, the image is updated in two ways: First, the camera image is updated as a result of the changing perspective of the camera upon the real world. Second, the gaming software 190 running the gaming simulation, changing the display of the overlaid graphical pyramid, adjusting the size and location of display of the overlaid pyramid such that it now appears closer to the player upon the display.

If the player takes another step forward, further changing the location of the portable gaming system 110 that he or she is carrying within he real physical space, the image is again updated in two ways. First, the camera image is updated as a result of the changing perspective of the camera upon the real world. Second, the software running the gaming simulation, changing the display of the overlaid simulated object 1510, adjusting the size and location of display of the simulated object 1510 such that it now appears closer to the player upon the display 160. The player thereby approaches the simulated object 1510 in this way.

When the player nears the simulated object 1510 to within a particular minimum distance, or actually stands upon or over the simulated location of the simulated object, the object is acquired—i.e, the simulation determines that the object is reached and picked up. In some embodiments a button press or other manual action upon the portable gaming system 110 may be required to select the object.

Either way, if the object is a treasure with associated points (as it is in this example), the score of the player is incremented. In other cases the simulated object 1510 that was approached could be simulated food, simulated medicine, simulated fuel, simulated ammunition, and/or simulated weapons, in which the gaming action is updated appropriately.

In other embodiments the simulated object 1510 that is approached is a bomb or other dangerous object that if collided with or stood upon causes damage and/or a reduction in score.

In other embodiments, as to be described later, the simulated object could be a note left by another player or a note that is computer generated. If the player approaches and acquires the note by carrying the portable gaming system 110 to a correct location within the real/simulated playing field, the note is displayed to the player.

In addition to the methods described in the paragraph above, other factors can be used to increment and/or decrement scoring variables upon the portable gaming system 110. For example a clock or timer upon the portable gaming system 110 can be used to determine how much time elapsed during a period in which player carries his or her portable gaming system 110 about the real physical space in order to perform a certain task or achieve a certain objective. The elapsed time, as monitored by gaming software 190 running upon the portable gaming system 110, adds to the challenge of the gaming experience and provides additional metrics by which to determine gaming performance of a player.

ix) Leaving Notes and Finding Notes

As described previously, a novel method disclosed herein is the ability for a player to leave a note for another player within said merged on-screen off-screen activity, said note being placed at a particular location within the real physical space within the users are playing, said notes being text information and/or audio information and/or image information. Using the methods and apparatus disclosed herein a user who wants to leave a note at a particular location can walk to that location, his position (and optionally orientation) being tracked by one or more sensor methods disclosed herein (or similar to disclosed herein). In some embodiments the senor used is a GPS sensors. When the user is at that location the user can compose and leave a note by using the user interface menus upon the portable gaming system 110. That note is then associated with the spatial location the user was at when he left the note, said association being stored in memory within one or more of said portable gaming systems 110. For example the note is associated with the particular GPS location (and optionally orientation) the user was at when he left the note (or a certain range of GPS locations near to where the user was when he left the note). When another user goes to that location (and optionally orientation) he or she can access that note. In this way users can leave notes to each other, said notes associated with particular places within the shared real/shared gaming environment. This is a particularly fun means of player to player communication for use in outdoor games in a large spatial area such as a park. In some embodiments that include many players a note may be left such that it is accessible only to a certain one or ones of said many players. For example a note can be left by a player, as configured in software, to only be accessible to teammates of that player and not to opponents of that player.

x) Gaming Scenarios

The unique methods and apparatus disclosed herein enable a wide variety of gaming scenarios that merge simulated gaming action with real world user motion through a real physical space. Said gaming scenarios can be single player or multi player. As one simple example of such gaming action, a game scenario is enabled upon a portable gaming system 110 by software running upon said portable gaming system 110 that functions as follows: two players compete head to head in a task to gather the most simulated treasure (e.g. cubes of gold) while battling each other using simulated weapons. Each user has a portable gaming system 110 equipped with a digital video camera and an accelerometer sensor. The two portable gaming systems 110 are also in communication with each other by a wireless communication links. In this case, the wireless communication links use Bluetooth technology. The game begins by each user walking to different rooms of a house and selecting the “start game” option on the user interface of their portable gaming system 110. An image appears upon each player's portable gaming system 110, said image a composite of the video feedback from the camera mounted upon their portable gaming system 110 combined with overlaid graphical imagery of a simulated cockpit (including windows and dashboard meters and readouts). For example, D'Fusion software from Total Immersion allows for real-time video to be merged with 3D imagery with strong spatial correlation. As another example, the paper Video See-Through AR on Consumer Cell-Phones by Mathias Möhring, Christian Lessig, and Oliver Bimber of Bauhaus University which is hereby incorporated by reference

The overlaid graphical imagery includes a score for each user, currently set to zero. The overlaid graphical imagery also includes a distance traveled value for each user and is currently set to zero. The overlaid graphical imagery also includes a damage value for each user and is currently set to zero. The overlaid graphical imagery also includes a fuel level value and an ammunition level value, both presented as graphical bar meters shown in FIG. 8. The full fuel level is represented by the red bar along the top of the display and the full ammunition level is represented by the green bar along the top of the display. The fuel level bar and ammunition level bar are displayed at varying lengths during the game as the simulated fuel and simulated ammunition are used, the length of the displayed red and green bars decreasing proportionally to simulated fuel usage and simulated ammunition usage respectively. When there is no fuel left in the simulated tank, the red bar will disappear from the display. When there is no ammunition left in the simulated weapon the green bar will disappear from the display. Also drawn upon the screen is a green crosshair in the center of the screen. This crosshair represents the current targeting location of the simulated weapon controlled by said user, said targeting location being shown relative to the real physical environment of said user.

Once the game has been started by both players, they walk about the real physical space, glancing down at the updating screens of their portable gaming systems 110. As they move the camera feedback is updated, giving each player a real-time first-person view of the local space as seen from the perspective of their portable gaming system 110. They are now playing the game—their gaming goal as moderated by the gaming software running on each portable gaming system 110 for each player to move about the real physical space of the house, searching for simulated targets that will be overlaid onto the video feedback from their camera by the software running on their portable gaming system 110. If and when they encounter their opponent they must either avoid him or engage him in battle. In this particular gaming embodiment, the simulated targets are treasure (cubes of gold) to be collected by walking to a location that is within some small distance of the simulated treasure. The software running upon each portable gaming system 110 decides when and where to display such treasure based upon the distance traveled by user (as determined by the accelerometer sensors measuring the accrued distance change and orientation change of the portable gaming system 110 they are carrying). As the gold cubes are found and encountered, the score of that user is increased and displayed upon the portable gaming system 110. Also displayed throughout the game are other targets including additional fuel and additional ammunition, also acquired by walking to a location that appears to collide with the simulated image of the fuel and/or ammo. When simulated fuel and/or simulated ammo are found and reached, the simulated fuel levels and/or simulated ammo levels are updated for that player in the simulation software accordingly.

The game ends when the time runs out (in this embodiment when 10 minutes of playing time has elapsed) as determined using a clock and/or timer within one or both portable gaming systems 110 or when one of said players destroys the other in battle. The player with the highest score at the end of the game is the winner.

xi) Advanced Tracking Embodiment

In an embodiment (particularly well suited for outdoor game play in a large open space) an absolute spatial position and/or orientation sensor is included upon each of the portable gaming systems 110.

For example if the portable gaming system is a Sony PlayStation Portable a commercially available GPS sensor can be plugged into the USB port of said device and is thereby affixed locally to the device. A first GPS sensor is incorporated within or connected to a first portable gaming system 110. A second GPS sensor is incorporated within or connected to a second portable gaming system used by a second player. Spatial position and/or motion and/or orientation data derived from said GPS sensor on each of said portable gaming systems and is transmitted to the other of said portable gaming system over said bi-directional communication link. In this way the portable gaming system software running upon each portable gaming system 110 has access to two sets of GPS data.

A first set of GPS data that indicates the spatial position and/or motion and/or orientation of that portable gaming system itself and a second set of GPS data that indicates the spatial position and/or motion and/or orientation of the other of said portable gaming systems. Each portable gaming system can then use these two sets of data and compute the difference between them thereby generating the relative distance between the two portable gaming systems, the relative orientation between the two portable gaming systems, the relative speed between the two portable gaming systems, and/or the relative direction of motion between the two portable gaming systems. Such difference information can then be used to update gaming action. Such difference information can also be displayed to the user in numerical or graphical form.

For example the relative distance between the portable gaming systems can be displayed as a numerical distance (in feet or meters) upon the display of each portable gaming system. In addition an arrow can be displayed upon the screen of each portable gaming system, said arrow pointing in the direction from that portable gaming system to the other said portable gaming system. In addition a different colored arrow can be displayed upon the screen of said portable gaming system indicating the direction of motion (relative to the portable gaming system) the other portable gaming system. Using such display information, the player of said gaming system can keep track of the relative position and/or orientation and/or motion of the other player during gaming action.

The above example is given with two players, a larger number of players, each with their own portable gaming systems, could be incorporated in some embodiments. In some gaming scenarios said multiple players are opponents. In other cases said multiple players are teammates. In some embodiments the position, motion, and/or orientation of only certain players are displayed to a given player—for example only of those that are teammates in the gaming scenario. In other embodiments the position, motion, and/or orientation of only other certain players are displayed to a given player. For example, only those that are within a certain range of said portable gaming system of that player, or only players that are opponents of that player, or only players that do not then currently have a simulated cloaking feature enabled, or only players that do not have a simulated radar-jamming feature enabled, or only players do not have a shield feature enabled, or only players that are not obscured by a simulated terrain feature such as a mountain, hill, or barrier.

In another embodiment above including a plurality players, each with a spatial position sensor such as GPS connected to their portable gaming system, the user of said first portable gaming system can be displayed either the position, motion, and/or orientation of said plurality players relative to said first portable gaming system. Said display can be numerical, for example indicating a distance between each of said portable gaming systems and said first portable gaming system. Said display can also be graphical, for example plotting a graphical icon such as dot or a circle upon a displayed radar map, said displayed radar map representing the relative location of each of said plurality of portable gaming systems relative to said first portable gaming system or relative to a fixed spatial layout of the playing field. The color of said dot or circle can be varied to allow said user to distinguish between the plurality of portable gaming systems. For example in one embodiment all teammate players are be displayed in one color and all opponent players are displayed in another color. In this way that player can know the location of his or her teammates and the location of his or her opponents. Also if there are entirely simulated players operating along said real players in the current gaming scenario the locations of said simulated players can optionally be displayed as well. In some embodiments the simulated players are displayed in a visually distinct manner such that they can be distinguished from real players, for example being displayed in a different color, different shape, or different brightness. Note—although the description above focused upon the display of said first player upon said first portable gaming system, it should be understood that a similar display can be created upon the portable gaming system of the other players, each of their displays being generated relative to their portable gaming system. In this way all player (or a selective subset of players) can be provided with spatial information about other players with respect to their own location or motion.

In another embodiment such as the ones described above in which a single portable gaming system receives data (such as GPS data) from a plurality of different portable gaming systems over bi-directional communication links, a unique ID can be associated with each stream or packet of data such that the single portable gaming system 110 can determine from which the portable gaming system the received data came from and is associated with.

If a particular player has a simulated cloaking feature or a simulated radar jamming feature enabled at a particular time, the portable gaming system for that player can, based upon such current gaming action, selectively determine not to send location information to some or all of the other portable gaming systems currently engaged in the game.

Similarly, if a particular player is hidden behind a simulated mountain or barrier, the portable gaming system for that player can, based upon such current gaming action, selectively determine not to send location information to some or all of the other portable gaming systems currently engaged in the game.

xii) Storing and Displaying Trajectory Information

Another feature enabled by the methods and apparatus disclosed herein is the storing and displaying of trajectory information.

Position, orientation or motion data related to the location of a portable gaming system as it is carried about a playing environment by a user is stored in the memory of the portable gaming system 110 along with time information indicating the absolute or relative time when the position, orientation, or motion data was captured.

This feature yields a stored time-history of the portable gaming system position, orientation, or motion data saved within the memory of the portable gaming system. The time history is used to update the gaming action. In some embodiments the user can request to view a graphical display of the time history, the graphical display for example being a plot of the position of the portable gaming system during a period of time.

If for example the user had carried his or her portable gaming system around a room by traversing a large oval trajectory, an oval shape is plotted upon the portable gaming system.

In other embodiments the scoring of the game is based in whole or in part upon the stored time-history of the portable gaming system 110 position, orientation, or motion data. For example the game might require a player to perform a “figure eight” by walking or running about playground.

The gaming software 190 running upon the portable gaming system 110 can score the user's ability to perform the “figure eight” by processing the time-history data and comparing the data with the characteristic figure eight shape. In this way a user's ability to perform certain trajectories within spatial or temporal limits can be scored as part of the gaming action.

In other embodiments, the engagement of simulated elements within the gaming action is dependent upon the time history data. For example, certain simulated treasures within a gaming scenario might only be accessible when reaching that treasure from a certain direction (for example, when the user comes upon the treasure from the north). To determine how the user comes upon a certain location, as opposed to just determining if the user is at that certain location, the gaming software 190 running upon the portable gaming system 110 can use the time-history of data.

xiii) Physical Space Targeting on a Gaming System

One of the valuable features enabled by the methods and apparatus disclosed herein is the ability for a player of the portable gaming system 110 to target real physical locations and/or real physical objects with a graphical crosshairs.

In one embodiment the video image of a physical space is captured by a camera mounted upon the portable gaming system, the direction and orientation of the camera dependent upon the direction and orientation that the portable gaming system is held by the user with respect real physical space. The video image from the camera is displayed upon the screen of the portable gaming system for a user to view. A graphical image of a crosshair is drawn overlaid upon the video image, the graphical image of the crosshair being drawn at a fixed location upon the screen of the portable gaming system, for example at or near the center of the screen, as shown in FIG. 3 and FIG. 8 herein.

The user then moves the portable gaming system about the real physical space by walking in some direction, turning in some direction, or otherwise changing his or her position and/or orientation within the real physical space. In response to the user motion, the portable gaming system is moved in position and/or orientation with respect to the real physical space. Updated video images are captured by the camera mounted upon the portable gaming system, the images depicting a changing perspective of the real physical space based upon the motion of the portable gaming system, the images displayed upon the screen of the portable gaming system. Also the graphical image of the crosshairs continue to be drawn overlaid upon the updated video image, the location of the crosshairs being drawn at the fixed location upon the screen of the portable gaming system.

Because the crosshairs are displayed at a fixed location upon the screen while the video image is changing based upon the motion of the portable gaming system as imparted by the user, the player is given the sense that the crosshairs are moving about the real physical space (even though the crosshairs are really being displayed at a fixed location upon the screen of the portable gaming system).

In this way a user can position the crosshairs at different locations or upon different objects within the remote space, thereby performing gaming actions. For example, by moving the position and/or orientation of the portable gaming system as described herein, a player can position the crosshairs upon a particular object within the real physical space. Then by pressing a particular button (or by adjusting some other particular manual control) upon the portable gaming system, the user identifies that object, selects that object, fires upon that object, and/or otherwise engages that object within the simulated gaming action. In this way a video camera affixed to the portable gaming system, the video camera capturing video images of changing perspective of the real physical space, can be used with gaming software that generates and displays graphical crosshairs overlaid upon the video images, the graphical crosshairs drawn at a fixed location while the video image is changing in perspective with respect to the the real physical space, allows the player to target, select, or otherwise engage a variety of real physical locations and/or real physical objects while playing a simulated gaming scenario.

This creates a combined on-screen off-screen gaming experience in which a user can carry a portable gaming system about a real physical space while engaging simulated gaming actions that are perceived as relative to and/or dependent upon the real physical space.

xiv) Movable Crosshairs

Now referring to FIG. 8, a pair of hands is shown holding 800 a portable gaming system 110 with a display 160, player input 170, and crosshairs 810 overlaid on the screen display as controlled by the gaming software 190.

A crosshairs 810 (or other overlaid targeting graphics) used by the methods disclosed herein can be moved about the display of the portable gaming system based upon player input 170 of the portable gaming system 110. In this way the crosshairs 810 need not remain at the center of the display 160 or at some other fixed location upon the display 160 of the portable gaming system 110, but can be moved about the display 160 and thereby be overlaid upon the video stream at different locations based upon the player input 170.

xv) Artificially Imposed Time Delay

Another embodiment is an artificially imposed time delay between the captured image from the video camera 120 and the displayed image upon the screen 160 of the portable gaming system 110.

Under normal operation the time delay between image capture and image display is very small, so small it is not perceptible or minimally perceptible by a human user. This allows for smooth and natural navigation through the merged real/simulated physical space. However under certain conditions the gaming software running upon the portable gaming system can impose an artificial time delay between image capture and image display so as to deliverately degrade the navigation responsiveness within the merged real/simulated physical space.

For example if a player suffers more than a threshold level of damage within the simulated gaming action or if the player is hit by a particular type of weapon within the simulated gaming action or if the player enters a particular simulated region within the simulated gaming space the gaming software running upon the portable gaming system 110 can impose an artificial time delay between image capture and image display, thereby increasing the difficulty of game play and/or simulating the effect of damage upon the player.

The artificially imposed time delay is an amount of time, moderated by the gaming software, that is waited between the time that an image is captured and that image is displayed. In this way the image stream displayed upon the screen of the portable gaming system will be an old image stream by the amount of time imposed by the artificial time delay. In some embodiments the artificially imposed time delay can be as short as a few hundred milliseconds. In other embodiments the artificially imposed time delay can be as long as a few seconds. In other embodiments the artificially imposed time delay can be set and/or varied in software at different values in the range from a few hundred milliseconds to a few seconds dependent upon the gaming action. For example if the user suffers a small amount of damage an artificially imposed time delay might be set in software of 500 milliseconds, the time delay being imposed for a period of 15 seconds. Also, if the user suffers a larger amount of damage an artificially imposed time delay might be set in software of 1.8 seconds, the time delay being imposed for a period of 30 seconds. In this way the hindrance cause by artificially imposed time delay can be moderated in software consistent with the demands of the gaming action. Note—in some embodiments special weapons within the software cause artificially imposed time delays to be imposed while other weapons do not. Thus if a user is hit by a weapon that causes a time delay, the software imposes the artificial time delay but if a user is hit by a different weapon the software does not. Other weapons, for example, can cause other hindrances to the user such as dimming the camera image and/or blurring the camera image and/or limiting the displayed range of the camera image. In this way different weapons can hinder users in different ways.

xvi) Simulated Sound Effects Coordinated with Real Physical Motion about Space:

As described previously the portable gaming system can display computer generated sounds to a user based upon the combined on-screen off-screen gaming action, the sounds controlled by software running upon the portable gaming system and output to the user through speakers and/or headphones upon and/or connected to the portable gaming system. One unique and powerful method of adding sound effects that enhance the first person real/simulated gaming experience is to provide sounds that are directly responsive to user motion within the real physical space and increase the illusion that the users motion is accompanied by and/or merged with simulated gaming action. In some embodiments wherein the user is controlling a simulated vehicle and/or simulated machine through his or her physical motion about the real physical space, simulated engine sounds are produce by the portable gaming system, the engine sounds dependent in whole or in part upon real user motion about the real physical space. For example, when the user is standing still within the real physical space, low volume and/or low frequency engine sounds are produced for the user consistent with engine idling. When the user starts walking within the real physical space, as detected by one or more of the location and/or motion sensing methods described previously, the software running upon the portable gaming system modifies the engine sounds, increasing the volume and/or frequency consistent with an engine that is now working harder. When the user moves faster within the real physical space, as detected by one or more of the location and/or motion sensing methods described previously, the software running upon the portable gaming system modifies the engine sounds, increasing the volume and/or frequency even further, consistent with an engine that is now working even harder. In addition, the simulated sound of transmission gear changes can be produced by gaming software dependent upon the changing speed of the user within the real physical space.

In other embodiments more abstract “ping” sounds (similar to the pings produced by radar) are produce by the portable gaming system, the “ping” sounds dependent in whole or in part upon real user motion about the real physical space. For example, when the user is standing still within the real physical space, low frequency “ping” sounds are produced. When the user starts walking within the real physical space or turns within the real physical space such that the portable gaming system is changes its orientation within the real physical space, as detected by one or more of the location and/or motion sensing methods described previously, the software running upon the portable gaming system increases the frequency of the “ping” sounds. When the user moves even faster within the real physical space, as detected by one or more of the location and/or motion sensing methods described previously, the software running upon the portable gaming system increases the frequency of the “ping” sounds even further.

In other embodiments more biological sounds are produce by the portable gaming system, the biological sounds including heartbeat sounds and/or breathing sounds, the biological sounds dependent in whole or in part upon real user motion about the real physical space. For example, when the user is standing still within the real physical space, low frequency and/or low volume breathing and/or heartbeat sounds are produced. When the user starts walking within the real physical space within the real physical space, as detected by one or more of the location and/or motion sensing methods described previously, the software running upon the portable gaming system increases the frequency and/or volume of the heartbeat and/or breathing sounds. When the user moves even faster within the real physical space, as detected by one or more of the location and/or motion sensing methods described previously, the software running upon the portable gaming system further increases the frequency and/or volume of the breathing and/or heartbeat sounds.

What is claimed is:

1. An apparatus for combined on-screen and off-screen player entertainment, said apparatus comprising:
a plurality of portable gaming systems running gaming software; each of the portable gaming systems adapted to be moved about a real physical space by a user, each of said portable gaming systems including a visual display, user input controls, a local camera, and a wireless communication link;
each of said portable gaming system operative to receive real-time image data from its local camera, said real-time image data comprising a first-person view of said real physical space, and display a representation of said image data upon said visual display, said portable gaming system also operative and sending gaming status information to other portable gaming systems over said communication link; and
gaming software running upon each of said portable gaming system, said gaming software operative to monitor game play and provide its user with an on-screen/off-screen gaming experience, the gaming experience providing one or more simulated gaming features that are overlaid upon the visual display of said real-time image data.

2. The apparatus as in claim 1; wherein said one or more simulated gaming features includes crosshairs that are overlaid upon said real-time image data.

3. An apparatus as in claim 1 wherein said one or more simulated gaming features includes a simulated terrain feature overlaid onto the real-time image data.

4. The apparatus as in claim 1 wherein the portable gaming system further comprises:
a location system;
wherein said location system is connected to the gaming software and provides position and/or orientation data relating to the location of said portable gaming system within said real physical space.

5. The apparatus as in claim 1 wherein the portable gaming system further comprises:
a ranging sensor;
wherein said ranging sensor is connected to the gaming software.

6. The apparatus as in claim 1 wherein the portable gaming system further comprises:
an audio input;
wherein said audio input is connected to the gaming software.

7. The apparatus as in claim 1 wherein the portable gaming system further comprises:
an audio output;
wherein said audio output is connected to the gaming software.

8. The apparatus as in claim 1 wherein the portable gaming system further comprises:
a light emitter-detector pair, wherein said light emitter-detector pair are tuned to approximately the same frequency and wherein the light detector provides a signal to the gaming software when the corresponding light emitter is activated.

9. The apparatus as in claim 1 wherein the portable gaming system is contained within a structure that is approximately the size of a wristwatch.

10. The apparatus as in claim 1 wherein a first portable gaming system directly communicates with the other portable gaming systems over a wireless communications link.

11. The apparatus as in claim 1 wherein the apparatus further comprises: a central processor, said central processor comprising a communications link and a message routing software; wherein said messages from a first portable gaming system is routed to a second gaming system and wherein said response from said second gaming system is routed to said first gaming system; such that the message routing software provides real-time interaction between users.

12. The apparatus as in claim 1 wherein that the gaming software is further operative to:
maintaining a list of physical object images; and
maintaining a list of virtual objects, where the virtual objects are associated with the physical object images, and with the virtual objects being displayed as overlays upon said real-time image data.

13. The apparatus as in claim 1 wherein the gaming software is further operative to display upon the visual display a simulated cockpit.

14. The apparatus as in claim 1 wherein the gaming software is further operative to display upon said visual display, a simulated ammunition level for the portable gaming system.

15. The apparatus as in claim 1 wherein the gaming software is further operative to display upon said visual display, a simulated fuel and/or power level for the portable gaming system.

16. The apparatus as in claim 1 wherein the gaming software is further operative to display upon said visual display, a simulated shield strength level for a simulated shield of the portable gaming system, the simulated shield being operative to reduce the simulated damage imparted upon the portable gaming system by certain simulated events occurring during game play.

17. The apparatus as in claim 1 wherein the gaming software is further operative to display upon said visual display, a simulated damage level for the portable gaming system.

18. The apparatus as in claim 1 wherein the gaming software is further operative to display overlaid upon said real-time image data, a crosshair for a simulated weapon of the portable gaming system, the crosshair showing the location within the real physical world at which said simulated weapon is aimed.

19. The apparatus as in claim 4 wherein the location sensor further comprises an optical position sensor, said optical position sensor taking an optical picture of said real physical space and computing the velocity and orientation of the portable gaming system as computed by the differential shift of each picture.

20. The apparatus as in claim 4 wherein the location sensor further comprises an integrated magnetometer sensor.

21. The apparatus as in claim 4 wherein the location sensor further comprises an integrated GPS sensor.

22. A method for controlling a gaming apparatus that provides an on-screen off-screen entertainment experience within a real physical space, said method comprising:
providing a handheld gaming system with a visual display and camera, said handheld gaming system configured such that it may be carried about said real physical space by a user;
providing gaming software upon said handheld gaming system, said gaming software moderating game play, maintaining a game score, and generating at least one simulated gaming object.
obtaining a real-time camera image from said camera;
transferring the real-time camera image to the memory of a portable gaming system;
overlaying the real-time camera image with a visual representation of a simulated gaming object, said simulated gaming object representing an element within the simulated gaming experience provided by said gaming software;
displaying the real-time camera image with overlaid simulated gaming object on the screen of said handheld gaming system.
repeatedly updating said real-time camera image as said handheld computing device is carried about said real physical space by said user.

23. The method according to claim 22 wherein the gaming software is modified when the player of the portable gaming system hits a simulated barrier as a result of moving said portable gaming system within said real physical space.

24. The method according to claim 22 wherein the simulated gaming object is a simulated terrain feature as stored in the memory of the portable gaming system.

25. The method according to claim 22 wherein the user's ability to control gaming features and/or functions is modified by a simulated fuel level and/or damage level as maintained by said portable gaming system.

26. The method according to claim 22, wherein the portable gaming system emits a sound when said portable gaming system is in the proximity of a simulated gaming object.

27. The method according to claim 22 wherein the portable gaming system displays a score upon the visual display, said score being based at least in part upon communications with one or more other portable gaming systems.

28. The method according to claim 22 wherein the portable gaming system displays said score upon the visual display, said score being based at least in part a time duration.

29. The method according to claim 22 wherein the portable gaming system displays graphical treasure, fuel supply, and/or ammunitions supply overlaid on the real-time camera image on said visual display.

30. The method according to claim 22 wherein said portable gaming system is operative to display overlaid crosshairs upon said real-time camera image on the visual display, said crosshairs showing the location within the real physical world at which a simulated weapon of said portable gaming system is aimed.

31. The method according to claim 22 wherein the visual display overlays a crosshairs over said real-time camera image, and the user identifies a real-world object using the crosshairs with manual interaction.

32. The method according to claim 22 wherein the appearance of a visual time delay is created by creating a first-in, first-out image buffer said buffer depth proportional to the required time delay, placing the image in the top of the buffer, then removing the image from the end of the buffer, and displaying the removed image, such that the camera image displayed to the user upon said visual display is delayed.

33. The apparatus as in claim 1; wherein said one or more simulated gaming features includes simulated lighting conditions that are used to modify said real-time image data.

34. The apparatus as in claim 1; wherein said one or more simulated gaming features includes simulated weapons fire that is overlaid upon said real-time image data.

35. The apparatus as in claim 1; wherein said one or more simulated gaming features includes simulated damage that is overlaid upon said real-time image data.

36. The apparatus as in claim 1; wherein said one or more simulated gaming features includes simulated cockpit imagery that is overlaid upon said real-time image data.

37. A system for multi-player entertainment, said system comprising:
a plurality of portable gaming systems; each of the portable gaming systems adapted to be moved about a real physical space by a user, each of said portable gaming systems including a visual display, user input controls, a local camera, and a wireless communication link;
each of said portable gaming system operative to capture real-time image data with its local camera, said real-time image data comprising a first-person view of said real physical space, and transmit a representation of said image data to another of said portable gaming systems;
each of said portable gaming systems also operative to receive transmitted image data from another of said portable gaming systems and display a representation of said transmitted image data upon the screen of said portable gaming system; and
gaming software running upon each of said portable gaming system, said gaming software operative to monitor game play and provide a score based upon said game play.
